(19) United States
(12) Patent Application Publication
(10) Pub. No.: US 2026/0298611 A1
(43) Pub. Date: Oct. 1, 2026

(54) DEVICE FOR POSITION SECURING

(71) Applicant: BOURNS, INC., Riverside, CA (US)

(72) Inventors: Péter Madarász, Márkó (HU); Andreas Sommer, Prien (DE)

(21) Appl. No.: 19/635,537

(22) Filed: Mar. 31, 2026

(30) Foreign Application Priority Data
Apr. 1, 2025 (DE) 10 2025 112 778.6

(51) Int. Cl. G01B 7/30; B62D 5/04; B62D 15/02

(52) U.S. Cl. CPC G01B 7/30; B62D 5/0463; B62D 15/021; B62D 5/0409

(57) ABSTRACT

A device for position securing of a rotation angle sensor, which determines a rotation angle between a rotor and a stator, relative to a sensor carrier about a rotation axis. The device includes a base body, a torsionally rigid support bearing, seen in the circumferential direction about the rotation axis, for receiving a torsional force from the rotation angle sensor, and a spring held on the support bearing, which is configured to apply a restoring force to the sensor carrier, having at least one spring foot and a spring arm extending at least partially axially with respect to the rotation axis, which, seen in the circumferential direction about the rotation axis, comprises a forwardly oriented spring arm side and a rearwardly oriented spring arm side opposite the forwardly oriented spring arm side. The spring foot and at least one of the spring arm sides are arranged within the base body.

### RELATED APPLICATIONS

This application claims the benefit of German Patent Application No. DE 10 2025 112 778.6, filed Apr. 1, 2025, the entire content of which is hereby incorporated by reference.

### BACKGROUND OF THE INVENTION

The present invention relates to a device for position securing according to the preamble of current claim 1.

Such a device is known from DE 10 2022 103 722 A1.

### BRIEF SUMMARY OF THE INVENTION

It is the object of the invention to improve the known device.

The object is achieved by the features of the independent claims. Preferred further developments are the subject matter of the dependent claims.

Proceeding from a device for position securing of a rotation angle sensor, which determines a rotation angle between a rotor and a stator, relative to a sensor carrier about a rotation axis, comprising a base body, comprising a torsionally rigid support bearing, seen in the circumferential direction about the rotation axis, for receiving a torsional force from the rotation angle sensor, and comprising a spring which is configured to apply a restoring force to the sensor carrier, wherein the spring has at least one spring foot and a spring arm extending at least partially axially with respect to the rotation axis, which in turn, seen in the circumferential direction about the rotation axis, comprises a forwardly oriented spring arm side and a rearwardly oriented spring arm side opposite the forwardly oriented spring arm side, according to the invention the spring foot as well as at least one of the spring arm sides are arranged within the base body.

The stated device is based on the consideration that, in the device for position securing mentioned at the outset, a spring arm is used whose spring foot lies completely outside the supporting housing body or structural body. The spring arm is here designed in such a way that it has two opposite sides—one facing the base body and one facing away therefrom—so that the entire spring arm including its attachment point is attached externally to the supporting structure in the circumferential direction. This arrangement leads to the stress distribution in the region of the spring foot being unfavorable, since the spring foot is oriented forwardly or rearwardly in the circumferential direction about the rotation axis and the force transmission thus acts along the circumferential direction, so that the material stress due to torsion of the spring foot concentrates on an inwardly located V-shaped cutout between spring arm and base body. Repeated torsional loads lead in the long term to material fatigue or crack formation.

Here, the stated device starts from the consideration of relocating the direction of force introduction as well as the integration of the spring foot structurally in such a way that the material stress in the region of the spring foot is distributed better in the circumferential direction about the torsional movement. According to the invention, this is achieved in that the spring foot as well as at least one of the spring arm sides are arranged within the base body, so that the spring arm is no longer attached externally to the base body in the circumferential direction, but is received in the supporting structure in the axial direction. By this orientation of the spring foot in the direction of the rotation axis, an improved distribution of the mechanical stresses in the transition region between spring arm and base body at the spring foot results, in which torsional forces are no longer introduced into the structure via a tangential contact progression, but via an axially directed clamping region. The axial orientation enables a more area-based force transmission into a deeper material zone of the base body and thereby significantly reduces local stress peaks in the region of the spring foot. At the same time, by the integration into the base body, a geometric guidance is created which limits the movement of the spring arm and prevents overloading due to excessive deflection. An additional limiting wall is in principle no longer necessary. The resulting clamping within the base body forms a more stable, direction-optimized load path and thereby permits a load-appropriate design of the anti-rotation securing which cannot be achieved with the known tangential attachment in the device mentioned at the outset.

By the reduction of stress peaks, material fatigue, and uncontrolled spring travel exceedance in the region of the spring foot, significantly reduced failure rates in operation can be achieved with the device according to the invention. The changed force transmission via an axially oriented spring foot embedded within the base body leads to a more uniform stress distribution and reduces in particular the locally concentrated load peaks which were identified in the known construction as the cause of crack formation or fractures. This has a positive effect on the fatigue strength of the entire component and extends the service life even under cyclic or thermal loading. The geometric guidance of the spring arm within the base body furthermore ensures that the path of movement of the spring arm remains controlled and mechanical overloads due to excessive deflection are avoided. Overall, the result is a robust, series-stable solution with higher failure safety, lower maintenance requirement, and improved manufacturing tolerances, since the function-critical load points are geometrically defined and guided in a structurally protected manner.

In a further development, the base body comprises, with respect to the rotation axis in an axial direction, a circumferential base body wall within which the spring arm is arranged. In this way, the spring arm can be completely enclosed by a supporting hollow structure, which not only enables secure and defined axial clamping but at the same time realizes geometric guidance and mechanical limitation of the spring arm. By means of the circumferential wall, the movement space of the spring arm can be specifically defined and overloading due to excessive deflection can be mechanically prevented. In addition, the spring arm is reliably protected by the enclosing base body wall against external influences such as dirt, mechanical contact, or thermal peaks. The hollow structure furthermore allows a space-optimized integration into existing housing shapes and provides constructive freedoms for the arrangement of multiple spring arms or sensor components. Manufacturing advantages also arise, since the wall structure can be produced particularly efficiently as a rotationally symmetrical or segmented injection-molded part in a closed mold.

In an additional development, it is provided that the base body wall comprises a recess, seen in the axial direction of the rotation axis, within which the spring arm is arranged. In this way, the spring arm is not only guided spatially within the base body but is additionally received by a laterally and/or axially limited structure which enables precise and direction-defined guidance of the spring arm. The arrangement in a recess improves the structural integration of the spring arm, since the stresses from the spring arm can be introduced in a controlled manner into the surrounding wall structure and are not concentrated at a point on an externally located connection. Furthermore, by the geometry of the recess, a defined movement limitation of the spring arm can be achieved which prevents undesired excessive deflections and thereby increases the service life of the component. The arrangement recessed into the wall structure simultaneously provides increased protection of the spring arm against mechanical damage or environmental influences and creates constructive freedoms for further integration possibilities, for example for receiving additional guide or damping elements.

In a further advantageous embodiment, it is provided that the spring foot is arranged on a bottom side of the recess, seen in the axial direction of the rotation axis. In this way, the spring arm is introduced from its foot region in the axial direction into the base body structure and is anchored there over an area. The force introduction thus occurs along the rotation axis into the wall depth of the recess, whereby a particularly stable clamping with uniform stress distribution can be achieved. The embedding on the bottom side enables a low-loss return of bending and torsional forces into the surrounding material structure and minimizes critical stress peaks such as occur in tangential or laterally attached clamping arrangements. In addition, this results in a structurally clean separation between the active spring region and the passive, force-absorbing section of the base body, which is advantageous both for the spatial organization and for reproducibility in the manufacturing process.

It can furthermore be provided that the spring arm, in a relaxed state, is oriented parallel to the base body wall. In this way, a position-optimized resting position of the spring arm results, in which the spring arm, without preload or deflection, is guided along the wall structure over an area. The parallel orientation not only improves the guidance of the spring arm within the recess but also contributes to a particularly compact spatial design, since the spring arm in the unloaded state does not occupy additional volumes outside the wall contour. Furthermore, manufacturing is simplified by this geometry, since the spring arm geometry can be integrated more easily into rotationally symmetrical or linearly guided tool forms. The parallel orientation additionally supports a defined and repeatable deflection characteristic when force is applied, since the direction of deflection occurs exactly orthogonally to the original installation position.

In a further advantageous embodiment, a stiffening rib, preferably oriented radially to the rotation axis, is arranged within the base body wall. In this way, the mechanical stiffness of the wall structure can be increased in a targeted manner, in particular in the radial direction in which bending and shear forces may occur due to the action of the spring arm during deflection. The stiffening rib acts as a structural counter-support that assists the reception and dissipation of these forces while simultaneously preventing deformation or undesired compliance of the wall structure. As a result, the position of the spring arm within the recess is stabilized, and the restoring characteristic of the spring remains constant even under prolonged loading or temperature fluctuations. The stiffening rib can additionally serve as a guide element for the spring arm or as a contact surface for movement limitation, whereby the functional scope of the component can be constructively expanded.

In a further expedient embodiment, the base body wall is formed concave in the region of the support bearing, as seen from the rotation axis. In this way, a form-fitting embedding of the support bearing in a correspondingly shaped receiving structure results, whereby the component can self-center during assembly and can be securely positioned against relative rotation. The concave shape supports the uniform distribution of circumferential forces since it promotes a large-area contact behavior and reduces localized load concentrations. In particular when receiving torsional moments in the circumferential direction, the concave geometry leads to an improved force flow into the adjacent wall regions, which increases the torsional stiffness of the overall construction. In addition, the concave formation can be used as a defined contact surface for additional securing elements, for example locking lugs or fitting structures.

In a further embodiment, the base body wall, as seen from the rotation axis, has a bulge directed into an interior space enclosed by the base body wall, opposite the support bearing. In this way, a locally protruding structure is formed within the interior space which serves for targeted reinforcement, functional extension, or geometric adaptation. The bulge can thereby be used as a contact or limiting surface for the spring arm, for example for defined movement limitation or for positioning in the unloaded state. At the same time, the bulge acts structurally as an additional stiffening of the wall structure by increasing the bending stiffness in the axial direction and supporting the dimensional stability of the interior space. The bulge can furthermore serve to receive additional functional elements, for example damping zones, guide projections, or integrated locking lugs. Through the targeted arrangement on the side opposite the support bearing, a more uniform material distribution within the base body wall is additionally achieved, which reduces stress differences under torsional loading.

In a further embodiment, the base body, seen in the circumferential direction about the rotation axis, has a stop wall oriented in the circumferential direction on the rear side and/or on the front side. In this way, a defined mechanical limitation is created which restricts the movement either of the spring arm or of the entire housing or base body relative to the sensor carrier. The stop wall acts as a form-fitting retaining element during deflection in the circumferential direction and prevents the spring from being stressed beyond its intended working range. This contributes to the longevity of the component and reduces the risk of material fatigue due to excessive deformation. Depending on the arrangement on the front side and/or rear side, the stop wall can function as a one-sided or two-sided end stop and can optionally serve for adjustment or locking of the component in the installed state. Moreover, it supports a space-defining integration into surrounding housing or bearing structures.

According to a further aspect of the invention, a rotation angle sensor for detecting a rotation angle between a rotor and a stator comprises the rotor and the stator with a housing and a circuit board for evaluating an encoder field influenced by the rotor, as well as one of the stated devices for securing a rotational position of the housing relative to a sensor carrier about a rotation axis. Through the integration of one of the stated devices for position securing into the rotation angle sensor, several advantages result for the sensor function itself. In particular, the direction-defined, structurally stable connection of the housing achieves a reproducible fixation of the stator position relative to the rotor, whereby measurement accuracy, repeatability, and thermal stability of the sensor are improved. In addition, the long-term stability of the calibration is increased and the assembly process is simplified, which has a positive effect on the overall reliability of the sensor system.

### BRIEF DESCRIPTION OF THE DRAWINGS

The properties, features, and advantages of the present invention described above, as well as the manner in which these are achieved, become clearer in connection with the following description of the embodiments, which are explained in more detail with reference to the drawings. The drawings show:

FIG. 1 a structural view of a vehicle with a sensor for detecting a rotation angle and a torque,

FIG. 2 a structural view of the sensor for detecting a rotation angle and a torque from FIG. 1,

FIG. 3a a structural view of a conventional device for position securing of the sensor of FIG. 1 in the vehicle,

FIG. 3b a structural view of a device according to the invention for position securing of the sensor of FIG. 1 in the vehicle,

FIG. 4 a perspective view of the device according to the invention according to a first embodiment, and

FIG. 5 a perspective view of the device according to the invention according to a second embodiment.

In the figures, identical technical elements are provided with identical reference signs and are described only once. The figures are purely schematic and in particular do not represent the actual geometric relationships.

### DETAILED DESCRIPTION

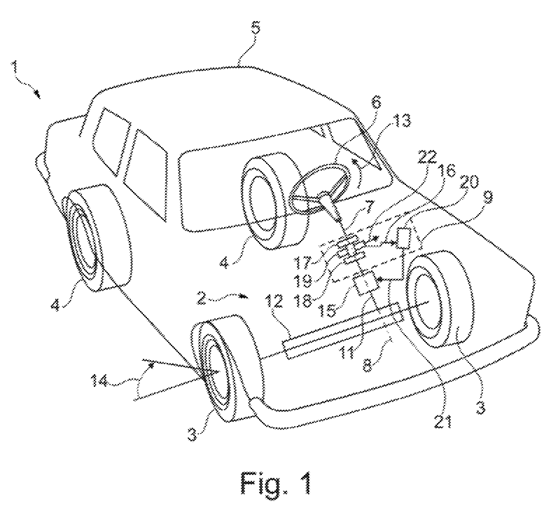

Reference is made to FIG. 1, which schematically shows a perspective view of a vehicle 1 with a steering system 2.

In the present embodiment, the vehicle 1 comprises a chassis 5 supported on two front wheels 3 and two rear wheels 4. The front wheels 3 can be steered via the steering system 2 so that the vehicle 1 can negotiate a curve.

The steering system 2 comprises a steering wheel 6 which is mounted on a first steering shaft 7, which in turn is arranged so as to be rotatable about a rotation axis 8. The first steering shaft 7 is guided into a sensor 9 for detecting a position, here in the form of an angular position, and is connected there, in a manner not specified further, with a torsion element 10. The torsion element has a freely selectable spring stiffness, which should preferably be selected constant and linear, and thereby converts an applied torque into a torque angle that can be detected by measurement. Connected to this torsion element 10, on the side opposite the first steering shaft 7 on the rotation axis 8, is a second steering shaft 11, which in turn ends in a steering gear 12. If the steering wheel 6 is rotated with a torque in the form of a steering torque 13, the steering torque 13 is correspondingly transmitted via the steering shafts 7, 11 to the steering gear 12, which in response steers the front wheels 3 with a wheel steering angle 14 for cornering.

The steering operation is assisted by an auxiliary motor 15 which co-rotates the second steering shaft 11. For this purpose, the steering torque 13 is derived from a rotation angle difference 16 between the first steering shaft 7 and the second steering shaft 11, which is detected by the inductive sensor 9. The auxiliary motor 15 then rotates the second steering shaft 11, among other things, as a function of the detected steering torque 13.

For detecting the aforementioned rotation angle difference 16 and thus the steering torque 13, the sensor 9 comprises a fine track 17 connected to the first steering shaft 7 and a coarse track 18 connected to the second steering shaft 11, which will be discussed in more detail at a later point. The sensor 9 further comprises a measuring circuit 19 fixed in place relative to the vehicle 1, which detects an angular position of the fine track 17 as well as an angular position of the coarse track 18 and determines the rotation angle difference 16 therefrom. This will also be discussed in more detail at a later point. Based on the rotation angle difference 16, a control unit 20 can now control the auxiliary motor 15 with a suitable control signal 21.

In addition to the rotation angle difference 16, the measuring circuit 19 of the sensor 9 also determines a rotation angle 22 of the entire steering shaft 7, 11 in order to use it, for example, in a vehicle dynamics system.

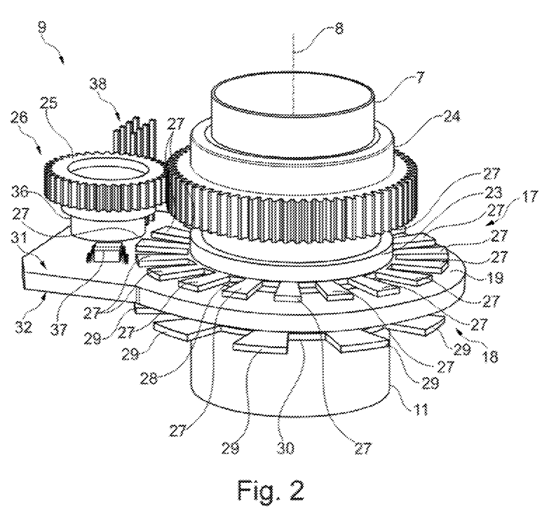

The structure of the sensor 9, which forms the basis for explaining the present embodiment, will be described in more detail below with reference to FIG. 2.

While the coarse track 18 is directly fastened to the second steering shaft 11 in a rotationally fixed manner, the fine track 17 is held on the first steering shaft 7 via a carrier sleeve 23. Furthermore, a drive wheel 24 is held in a rotationally fixed manner on this carrier sleeve 23, which drives a driven wheel 25 for a multi-angle detection device 26 in a manner that will be described later.

In the present embodiment, the fine track 17 is designed as a vane wheel with a number of fine track vanes 27 made of metal. The individual fine track vanes 27 are distributed equidistantly in the circumferential direction about the first steering shaft 7 and are held on a fine track carrier 28. For the further explanations, a number of twelve fine track vanes 27 will be assumed, although significantly more fine track vanes 27 are shown in FIG. 2.

Analogously, the coarse track 18 in the present embodiment is also designed as a vane wheel with a number of coarse track vanes 29 made of metal. The individual coarse track vanes 29 are likewise distributed equidistantly in the circumferential direction about the first steering shaft 7 and are held on a coarse track carrier 30 in a manner analogous to the fine track 17. For the further explanations, a number of eight coarse track vanes 29 will be assumed. From the perspective of FIG. 2, not all of these coarse track vanes 29 are visible.

By means of the coarse track vanes 29 and the fine track vanes 27, the measuring circuit 19 can determine the rotation angle 22. For this purpose, the measuring circuit 19 can in principle be configured as described in EP 3 865 824 A1.

The measuring circuit 19 has a fine track side 31 directed toward the fine track vanes 27 and a coarse track side 32 directed toward the coarse track vanes 29. On each side of the measuring circuit 19 there is arranged a transmitting coil, not shown in further detail, which preferably excites a high-frequency magnetic field, and at least one receiving coil, also not shown in further detail, in which a voltage is induced by the magnetic field. On the fine track side 31, a fine track signal is thus generated in the corresponding receiving coil, while on the coarse track side 32 a coarse track signal is generated in the corresponding receiving coil.

In this configuration of the measuring circuit 19, the vanes 27, 29 disturb the magnetic field generated by the respective transmitting coil, whereby the fine track signal and the coarse track signal change depending on the rotation angle of the respective track 17, 18. This basic configuration can be expanded in order, for example, to make the measuring system more robust against measurement errors. Such an expansion is discussed in the previously cited EP 3 865 824 A1. However, such extensions are not relevant for understanding the present embodiment.

For understanding the embodiment, it is only relevant that the vanes 27, 29 of the tracks 17, 18 produce track signals which change periodically with the angular position of the respective track 17, 18.

In addition to the track signals, the multi-angle detection device 26 also outputs a magnetic angle signal. This magnetic angle signal is generated in a magnetic sensor element 37 based on a radially magnetized magnet 36 which is arranged on the side of the driven wheel 25 facing the circuit board 19 and is rotated above the magnetic sensor element 37 by the driven wheel 25.

From the track signals and the magnetic angle signal, the rotation angle 22 of the entire steering shaft 7, 11 is then calculated on the circuit board 19 and output via an output interface 38.

In the sensor 9 described above, the measuring circuit 19 is fixed in place relative to the vehicle 1 and is therefore fixed relative to the rotation axis 8. In order for the angular positions of the fine track 17 and the coarse track 18 to be correctly detected, it is necessary that the measuring circuit 19—and thus the housing carrying it—is secured precisely in its rotational position against rotation relative to the rotation axis 8.

While this must be achieved in the circumferential direction—that is, about the rotation axis 8—by means of a suitable anti-rotation securing, the challenge of radial position securing of the housing relative to the rotation axis 8 also arises. This is because manufacturing tolerances, thermal expansion, or installation forces may lead to a radial displacement or inclination of the housing, which results in a displacement of the transmitting coils and receiving coils of the measuring circuit 19 relative to the vanes 27, 29 or relative to the magnet 36.

Such a radial position deviation can, particularly when using high-frequency magnetic fields, lead to a change in the coupling characteristic between coil and track vane, which in turn can influence the amplitude and phase position of the received track signals. This also applies analogously to the magnetic angle signal of the magnetic sensor element 37. Even small positional deviations in the sub-millimeter range can lead to systematic measurement errors or increased temperature sensitivity of the angle signals.

Against this background, a precise and permanently stable radial positioning of the measuring circuit 19 relative to a sensor carrier fixed in place with respect to the chassis 5 of the vehicle 1 is particularly important. A radial position deviation of the measuring circuit 19, for example as a result of manufacturing tolerances, temperature influences, or mechanical loading in the installed state, may lead to a displacement of the position of the transmitting coils and receiving coils of the measuring circuit 19 relative to the fine track vanes 27, the coarse track vanes 29, or the magnet 36. This displacement influences the coupling between the coils and the vane structures or the magnetic field, which may change the amplitude, phase position, or linearity of the detected track signals and the magnetic angle signal. In order to avoid this, the measuring circuit 19 must be held in a positionally accurate and form-fitting manner relative to the sensor carrier and thus to the chassis 5.

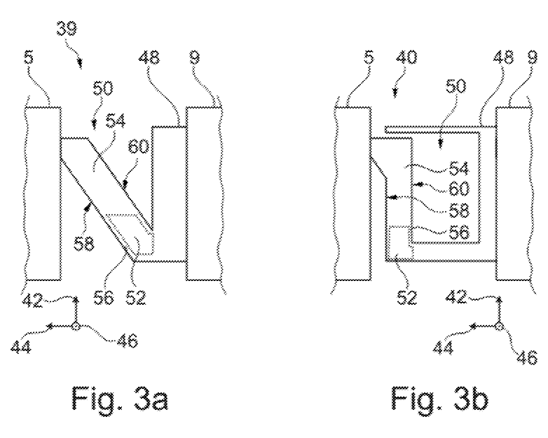

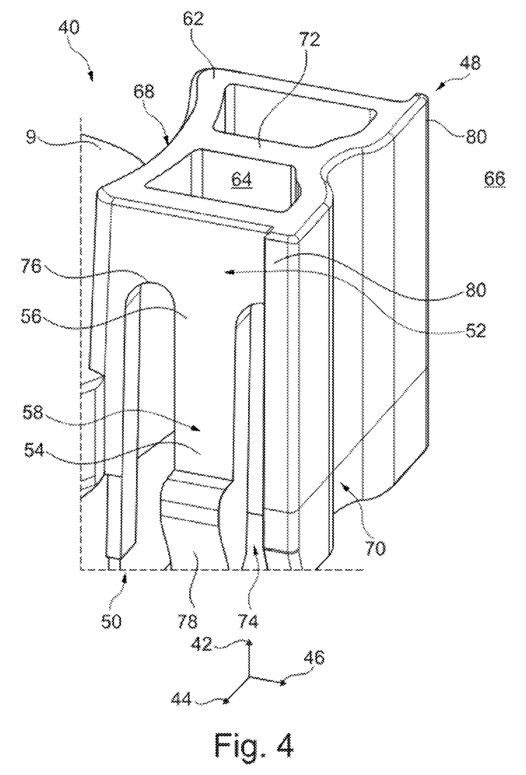

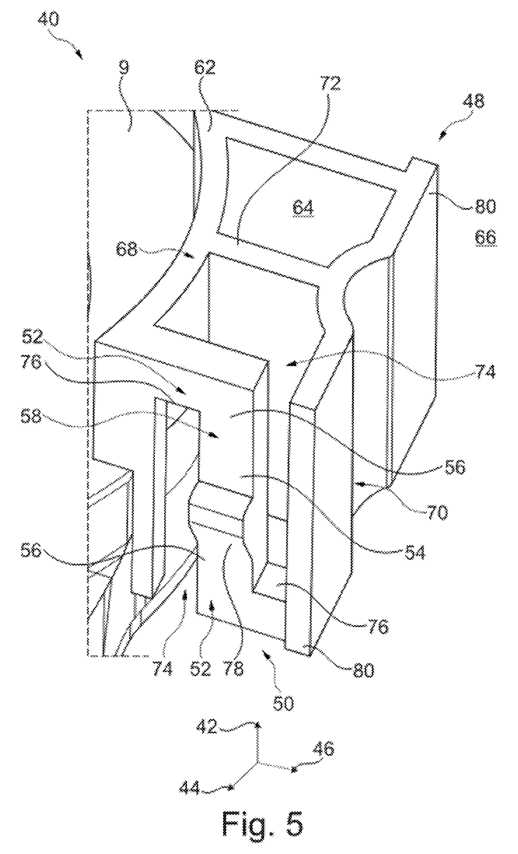

For this purpose, a device 40 for position securing of the sensor 9 in the vehicle 1 relative to the sensor carrier and thus the chassis 5 is used, which will first be explained in principle with reference to FIGS. 3a and 3b. FIG. 3a illustrates the principle of a conventional device 39, as known from DE 10 2022 103 722 A1, and FIG. 3b illustrates a device 40 according to the present invention. For simplification of the further illustrations, the devices 39, 40 will hereinafter be considered in a cylindrical coordinate system with an axial direction 42 extending parallel to the rotation axis 8, a circumferential direction 44 extending circumferentially about the rotation axis 8, and a radial direction 46 extending transverse to the axial direction 42 and transverse to the circumferential direction 44. For understanding the function, it is important in this context that the sensor 9 does not necessarily have to be located behind the devices 39, 40 in the circumferential direction 44. During operation, the sensor 9 is generally located behind the devices 39, 40 as seen in the radial direction 46, which is specifically shown in the later FIGS. 4 and 5.

Both the conventional device 39 and the device 40 according to the invention comprise a base body 48 and a spring 50 which is held on the base body 48 via a support bearing 52. The spring 50 is intended to apply a restoring force directed opposite to the circumferential direction 44 to the sensor carrier and thus to the chassis 5 in order to position the sensor 9 firmly in the circumferential direction 44 in the manner described above.

As in DE 10 2022 103 722 A1, the possibility of applying the restoring force by springs independent of the base body 48 is costly, complicated in manufacture, and maintenance-intensive, which is why a one-piece manufacture of the spring 50 with the base body 48 is proposed. The spring 50 of this known device 39 has a spring arm 54 which is connected to the support bearing 52 and thus to the base body 48 via a spring foot 56.

The conventional device 39, seen in the circumferential direction 44, has a first spring arm side 58 which is directed toward the sensor carrier and thus toward the chassis 5, and a second spring arm side 60 which is directed toward the base body 48. DE 10 2022 103 722 A1 teaches that the second spring arm side must be directed toward the base body 48, which results in the entire spring foot 56 and the support bearing 52 being located, seen in the circumferential direction 44, in front of the base body 48, and the spring arm 54 having to extend at an acute angle relative to the base body 48, since otherwise no restoring force can be applied.

However, this acute-angled arrangement of the spring arm 54 relative to the base body 48 and relative to the axial direction 42, and thus relative to the rotation axis 8, brings several disadvantageous effects with it. Firstly, the acute angle between the course of the spring arm 54 and the axial direction 42 leads to an unfavorable force flow in the region of the spring foot 56. The restoring force to be applied by the spring 50 must act essentially opposite to the circumferential direction 44, while the spring arm 54 enters the base body 48 at a strongly inclined angle. As a result, a torsional and bending load arises particularly at the location of the acute angle in the region of the spring foot 56, which is significantly greater than the mechanical load on the opposite underside of the conventional device 39 seen in the axial direction 42. This leads to an unfavorable redirection of force, which causes a local increase in stress in the material at the location of the acute angle and noticeably increases the risk of material fatigue or crack formation in the transition region between the spring foot 56 and the support bearing 52.

Furthermore, due to the acute-angled arrangement, a long, obliquely extending spring arm 54 is required in order to be able to apply the desired restoring force opposite to the circumferential direction 44 at all. This has a disadvantageous effect on the absolutely necessary installation space, since the spring 50 must extend noticeably away from the base body 48 in the circumferential direction 44 and the axial direction 42 in order to position the spring head opposite the spring foot 56 sufficiently far from the base body 48. The less installation space is available, the more difficult the integration of the sensor 9 becomes in correspondingly compact modules or housing shapes.

Finally, the geometric acute-angled configuration results in a restricted movement path of the spring arm in the direction of its main deflection. During a deflection in the direction of the sensor carrier, a rapid increase in bending load may occur, which limits the effective spring action and increases the risk of overloading under shock or continuous loading.

Here, the device 40 according to the invention addresses this with the idea of arranging the spring foot 56 as well as at least the second spring arm side 60 within the base body 48. Through this arrangement it becomes possible to align the spring arm 54 in a course that is essentially perpendicular to the circumferential direction 44, so that, upon a rotation of the sensor carrier, the spring arm moves along a line that runs orthogonally to the direction of the restoring force to be applied. This has several technical advantages:

Firstly, a material loading appropriate to the force flow is thereby achieved, since the restoring force of the spring 50 is now transmitted transverse to the main extension direction of the spring arm 54. The bending load is distributed more uniformly over the support bearing 52, whereby stress peaks in the material are reduced.

Secondly, by the right-angled geometry a shorter and more compact spring structure can be realized in which the force transmission occurs in a more linear and defined manner. The spring characteristic is easier to dimension, since no oblique bending paths are present that would affect the restoring force in a nonlinear manner. As a result, the reproducibility of the spring behavior is improved, particularly under changing temperatures or under continuous dynamic loads during driving operation. Moreover, the right-angled installation position in the base body 48 can be implemented more easily and robustly from a manufacturing perspective, since the shape provides clearly defined wall relationships along which the spring can be guided and supported.

A concrete embodiment of the device 40 according to the invention will now be described with reference to FIG. 4.

The base body of the device 40 of FIG. 4 is essentially of hollow cylindrical construction and has a base body wall 62 extending circumferentially about the axial direction 42, which separates an interior space 64 from an exterior space 66. As already indicated above, the spring 50 is located, seen in the circumferential direction 44, on the front side of the device 40, while the device 40 is attached to the sensor 9 on the rear side as seen in the radial direction 46. The attachment may take place by means of fastening means, but it may also take place through a one-piece configuration with parts of the sensor 9, such as for example a housing that encloses the components.

By a one-piece configuration it is to be understood that the base body 48—optionally together with the sensor component—is produced from a continuous material body in a single forming process, in particular by injection molding, without subsequent joining processes such as adhesive bonding, screwing, or clipping being required. Such a one-piece configuration ensures a force-locking and tolerance-free connection between the device 40 and the sensor 9, whereby a precise and permanently stable positioning is ensured. At the same time, the assembly effort is reduced, which is particularly advantageous in the context of automated production lines.

A further advantage of the one-piece configuration lies in the fact that force flows from the spring 50 can be introduced directly into the surrounding sensor structure without material or geometry transitions acting as potential weak points. This improves the mechanical robustness of the entire sensor assembly and increases the service life under cyclic loading. In addition, the one-piece integration opens constructive degrees of freedom in order, for example, to integrally form additional functions such as sealing lips, locking lugs, or plug contours.

On the front side as seen in the radial direction 46, the base body wall 62 is formed, in the region of a connection point to the sensor 9, with a concave bulge 68 extending into the interior space toward the front side as seen in the radial direction 46. In a similar manner, the wall on the outer side as seen in the radial direction 46 has a further bulge 70 extending into the interior space 64, so that the two bulges 68, 70 are directed toward one another and point toward one another with respective maxima that are not further referenced. At these maxima, the interior space 64 of the base body 48 is braced by a strut wall 72.

The concave bulges 68, 70 and their connection by the strut wall 72 act as a local stiffening unit which specifically stabilizes the base body wall in the region of the connection point. Through this shape, a double-shell structure with a strut-like connection is created, which in its effect is comparable to a local rib or sandwich structure. In particular under torsional or bending loads of the base body, the strut wall can introduce occurring forces over an area into the surrounding wall structure, whereby stress concentrations are avoided and material fatigue is reduced.

Since the connection point to the sensor 9 is arranged on the rear side of the device 40 as seen in the radial direction 56, it acts as a central force transmission point between the sensor 9 and the device 40. The bracing in the region of the bulge maxima supports the mechanical connection and ensures a directed return of the forces introduced there, in particular from the spring arm 54. In this context, the bulges assume the function of a force-flow-guiding volume, similar to a form-fitting body or a shaped load-path guide.

Through the concave shape on both sides of the base body wall 62, the material can be arranged in a load-appropriate manner without massive wall thicknesses being required. This saves weight and material costs while maintaining high stiffness. The symmetrical shape additionally supports uniform component cooling during injection molding and reduces the risk of sink marks or warpage.

The concave bulges also serve as assembly or guiding features, for example for axial positioning in a sensor carrier or as contact surfaces for seals, locking lugs, or guide sleeves. Through the central strut wall, a defined contact surface results which may also be used for additional functional elements, such as clips, centering pins, or the like.

The base body wall 62 has, on its front side as seen in the circumferential direction 44, an axial recess 74 extending upward from a lower side as seen in the axial direction 42, with a recess bottom 76 arranged at the upper end as seen in the axial direction 74, which connects the remaining base body wall 62 in the radial direction 64. On this recess bottom 76 the spring 50 stands, or rather hangs, opposite to the axial direction 42, so that the recess bottom 76 serves at this location as the support bearing. In the relaxed state, the spring 50 with its spring arm 54 is positioned, as seen in the circumferential direction 44, at the same level as the base body wall 62 and can pivot both into the interior space 64 and into the exterior space 66.

If the spring 50 must be protected against overstretching, a movement limitation of the spring 50 opposite to the circumferential direction 44 may be enforced by a suitable arrangement of the strut wall 72 or by additional stop means.

For fixation in the axial direction 42, a hook 78 may be formed at the end of the spring 50 opposite the spring foot 56, which creates an undercut as seen opposite to the axial direction 42 that can engage in a form-fitting manner with a corresponding counter-element on the sensor carrier held fixed relative to the chassis 5. For coarse positioning of the device 40, positioning walls 80 extending in and opposite to the circumferential direction 44 may be formed on the base body 48.

With reference now to FIG. 5, a further development of the device 40 is described in which the spring arm 54 of the spring 50 has a spring foot 56 at each of its ends as seen in the axial direction 42, so that the spring 50 is fixed to the base body 48 at two ends. The elasticity is achieved by splitting the recess bottom 76 explained above, so that two recesses 74 are formed which extend into the base body wall 62 in opposite directions as seen in the axial direction 42, and ultimately two recess bottoms 76 are formed.

In this way, the spring arm 54 is no longer formed as a freely projecting cantilever but as a bending beam structure clamped at both ends, which leads to a more symmetrical stress distribution in the material and thereby to higher fatigue strength. The transition regions of the spring feet 56 into the recess bottoms 76 are geometrically protected by the course of the base body wall 62 in FIG. 5 and embedded in a force-flow-optimized manner, which further reduces the risk of local stress peaks and fatigue fractures.

Furthermore, the double mounting allows a more defined movement kinematics of the spring arm 54, since it is symmetrically loaded and unloaded during deflection in the circumferential direction 44. This improves the restoring behavior and increases the reproducibility of the spring characteristic even under thermal or dynamic loads. The integration of both mounting points into the wall structure of the base body 48 furthermore enables a very compact construction, since the spring arm 54 is guided entirely within the wall thickness of the base body wall 62.

In addition, the double-sided anchoring creates the possibility of integrating further functional elements—such as damping elements, stops, or positioning aids—between the two mounting points. The spring 50 thus becomes a structural component which not only transmits restoring forces to the sensor carrier but also actively contributes to the mechanical stability of the device 40.

### REFERENCE NUMERAL LIST

1 Vehicle

2 Steering system

3 Front wheels

4 Rear wheels

5 Chassis

6 Steering wheel

7 First steering shaft

8 Rotation axis

9 Sensor

10 Torsion element

11 Second steering shaft

12 Steering gear

13 Steering torque

14 Wheel steering angle

15 Auxiliary motor

16 Rotation angle difference

17 Fine track

18 Coarse track

19 Measuring circuit

20 Control unit

21 Control signal

22 Rotation angle (entire steering shaft)

23 Carrier sleeve

24 Drive wheel

25 Driven wheel

26 Multi-angle detection device

27 Fine track vane

28 Fine track carrier

29 Coarse track vane

30 Coarse track carrier

31 Fine track side

32 Coarse track side

33 Fine track signal

34 Coarse track signal

36 Magnet

37 Magnetic sensor element

38 Output interface

39 Conventional device

40 Device according to the invention

42 Axial direction

44 Circumferential direction

46 Radial direction

48 Base body

50 Spring

52 Support bearing

54 Spring arm

56 Spring foot

58 First spring arm side

60 Second spring arm side

62 Base body wall

64 Interior space

66 Exterior space

68 Inner bulge

70 Outer bulge

72 Strut wall

74 Axial recess

76 Recess bottom

78 Hook

80 Positioning wall

1. A device (40) for position securing of a rotation angle sensor (9), which determines a rotation angle between a rotor and a stator, relative to a sensor carrier about a rotation axis (8), the device comprising:
a base body (48),
a torsionally rigid support bearing (52), seen in the circumferential direction (44) about the rotation axis (8), for receiving a torsional force from the rotation angle sensor (9), and
a spring (50) held on the support bearing (52), which is configured to apply a restoring force to the sensor carrier, having at least one spring foot (56) and a spring arm (54) extending at least partially axially (42) with respect to the rotation axis (8), which, seen in the circumferential direction (44) about the rotation axis (8), comprises a forwardly oriented spring arm side (58) and a rearwardly oriented spring arm side (60) opposite the forwardly oriented spring arm side,
wherein the spring foot (56) as well as at least one of the spring arm sides (58, 60) are arranged within the base body (48).

2. The device (40) according to claim 1, wherein the base body (48), with respect to the rotation axis (8), comprises, in an axial direction (42), a circumferential base body wall (62) within which the spring arm (54) is arranged.

3. The device (40) according to claim 2, wherein the base body wall (62) has a recess (74) seen in the axial direction (42) of the rotation axis (8), within which the spring arm (54) is arranged.

4. The device (40) according to claim 3, wherein the spring foot (56) is arranged on a bottom side (76) of the recess (74) seen in the axial direction (42) of the rotation axis (8).

5. The device (40) according to claim 1, wherein the spring arm (54), in a relaxed state, is oriented parallel to the base body wall (62).

6. The device (40) according to claim 1, wherein a stiffening rib is arranged within the base body wall (62).

7. The device (40) according to claim 6, wherein the stiffening rib is oriented radially (46) to the rotation axis (8).

8. The device (40) according to claim 2, wherein the base body wall (62) is formed concave in the region of the support bearing (52) as seen from the rotation axis (8).

9. The device (40) according to claim 2, wherein the base body wall (62), seen from the rotation axis (8) opposite the support bearing (52), has a bulge (70) directed into an interior space (64) enclosed by the base body wall (62).

10. The device (40) of claim 1, wherein the base body (48), seen in the circumferential direction (44) about the rotation axis (8), has a stop wall (80) oriented in the circumferential direction (44) on the rear side and/or on the front side.

11. A rotation angle sensor (9) for detecting a rotation angle between a rotor and a stator, the sensor (9) comprising the rotor and the stator with a housing and a circuit board (19) for evaluating an encoder field influenced by the rotor, and the device (40) according to claim 1 for securing a rotational position of the housing relative to a sensor carrier about a rotation axis (8).
